(19) United States
(12) Patent Application Publication
(10) Pub. No.: US 2011/0084209 A1
(43) Pub. Date: Apr. 14, 2011

(54) REPRODUCIBLE LATTICE STRAIN MEASUREMENT METHOD

(75) Inventors: Jayhoon CHUNG, Plano, TX (US); Guoda LIAN, Plano, TX (US)

(73) Assignee: TEXAS INSTRUMENTS INCORPORATED, Dallas, TX (US)

(21) Appl. No.: 12/901,069

(22) Filed: Oct. 8, 2010

Related U.S. Application Data
(60) Provisional application No. 61/249,635, filed on Oct. 8, 2009.

(51) Int. Cl. G01N 23/00

(52) U.S. Cl. 250/311

(57) ABSTRACT

Lattice strain is reproducibly measured using geometric phase analysis (GPA) of a high angle annular dark field mode scanning transmission electron microscope (HAADF-STEM). Errors caused by beam shift (also known as fly-back error) between scan lines are eliminated.

### CROSS-REFERENCE TO RELATED APPLICATIONS

This application claims the benefit of priority under U.S.C. §119(e) of U.S. Provisional Application 61/249,635 (Texas Instruments docket number TI-67805, filed Oct. 8, 2009.

### FIELD OF THE INVENTION

This invention relates to the field of transmission electron microscopy (TEM). More particularly this invention relates to the measurement of strain in crystalline materials using TEM.

### BACKGROUND OF THE INVENTION

As integrated circuits are scaling to smaller and smaller dimensions, the transistor performance improvement is not keeping pace. One method to improve transistor performance is to apply compressive stress to the channel region of PMOS transistors and tensile stress into the channel region of NMOS transistors.

For strained device development a technique that measures the local strain tensor in the channel regions of the device on a routine basis is needed. A commonly used method of measuring lattice strain utilizes a high resolution transmission electron microscope (HRTEM) image. The electrons in an HRTEM image are coherent and may interfere causing bright or dark spots to form depending upon the thickness of the sample and depending upon microscope parameters (such as depth of focus). Typically samples for HRTEM images are 30 nm to 80 nm in thickness. The thickness uniformity of an HRTEM sample is critical to produce a high quality HRTEM image. The field of view for HRTEM is typically 20 nm by 20 nm to 60 nm by 60 nm with a maximum field of view of about 100 nm by 100 nm. Control of the sample thickness and of the microscope parameters becomes much more difficult as the field of view gets larger. One method for measuring stress using HRTEM is to take the Fourier transform of the HRTEM image and then to perform geometric phase analysis (GPA). The Fourier transform of the HRTEM image of a perfect crystal results in pattern of sharply defined Bragg reflections. The Fourier transform of the HRTEM image of a crystal under strain with crystal planes displaced from the unstrained locations results in a pattern of Bragg reflections with a more diffuse intensity corresponding to the variations in the lattice structure. Such diffuse intensity in the diffraction pattern can be interpreted in terms of strain using GPA.

It is difficult to make reproducible strain measurements using HRTEM images because of the difficulty in reproducible sample preparation and optimization of the microscope parameters. In addition, since HRTEM samples must be thin, typically 30 nm to 80 nm, a significant portion of the stress may be relaxed. Small differences in sample to sample thickness may cause significant differences in the measured strain. So strain measured by HRTEM GPA is often not representative of the true strain in the sample.

### SUMMARY OF THE INVENTION

The following presents a simplified summary in order to provide a basic understanding of one or more aspects of the invention. This summary is not an extensive overview of the invention, and is neither intended to identify key or critical elements of the invention, nor to delineate the scope thereof. Rather, the primary purpose of the summary is to present some concepts of the invention in a simplified form as a prelude to a more detailed description that is presented later.

A method of reproducibly measuring lattice strain using geometric phase analysis (GPA) of a high angle annular dark field scanning transmission electron microscope (HAADF-STEM) image is described.

A method of eliminating errors caused by beam shift (also known as fly-back error) between scan lines is also described.

### DESCRIPTION OF THE VIEWS OF THE DRAWING

FIG. 1 is an illustration of a PMOS transistor with SiGe in the source and in the drain applying compressive stress to the channel region.

FIGS. 2A and 2B illustrate lattice deformation in the distance between crystal planes due to stress.

FIG. 3 is a HAADF-STEM image of a PMOS transistor with SiGe source and drain.

FIG. 4 is a Fourier transform diffractogram of the HAADF-STEM image in FIG. 3.

FIG. 5 is a strain map produced from the HAADF-STEM image in FIG. 3.

FIG. 6 illustrates fly-back errors that may occur in a STEM image.

FIG. 7. is a strain map produced from the HAADF-STEM image in FIG. 3 including fly-back errors.

FIG. 8. is a strain map of the same strain tensor component as FIG. 7 without fly-back errors.

### DETAILED DESCRIPTION

The present invention is described with reference to the attached figures, wherein like reference numerals are used throughout the figures to designate similar or equivalent elements. The figures are not drawn to scale and they are provided merely to illustrate the invention. Several aspects of the invention are described below with reference to example applications for illustration. It should be understood that numerous specific details, relationships, and methods are set forth to provide an understanding of the invention. One skilled in the relevant art, however, will readily recognize that the invention can be practiced without one or more of the specific details or with other methods. In other instances, well-known structures or operations are not shown in detail to avoid obscuring the invention. The present invention is not limited by the illustrated ordering of acts or events, as some acts may occur in different orders and/or concurrently with other acts or events. Furthermore, not all illustrated acts or events are required to implement a methodology in accordance with the present invention.

High angle annular dark field scanning transmission electron microscope images (HAADF-STEM) images are formed from incoherent elastically scattered electrons. The scattered intensity is a sum of independent scatterings from individual atoms, so the incoherent images of HAADF-STEM may be interpreted more directly in terms of atom types and positions. Strain measurements using HAADF-STEM GPA has several advantages over HRTEM GPA. One of the advantages is that the HAADF-STEM imaging technique does not show contrast reversal with specimen thickness and microscope parameters such as depth of focus. Another advantage is that HAADF-STEM images may be obtained from samples up to 250 nm thick so strain relaxation due to sample thinning is avoided in contrast to HRTEM images which require samples thinned to 30 nm to about 80 nm. Sample preparation requirements for HAADF-STEM are much less stringent than for HRTEM enabling more reproducible stress measurements. Additionally, the field of view of HAADF-STEM images may be significantly larger, up to 300 nm×300 nm, than HRTEM images which are limited to about 100 nm by 100 nm allowing the stress of an entire MOS device, including the source, drain, substrate, and channel region to be mapped within one image, which can provide a better unstrained reference area for GPA analysis.

The electrons, which are deflected at large angles, are incoherent and generate HAADF-STEM images such as the example image of a PMOS transistor shown in FIG. 3. Unlike the coherent electrons which form a HRTEM image, these incoherent electrons do not have the problem of contrast reversal with small changes in specimen thickness and depth of focus.

FIG. 1 is a cross-sectional diagram of a PMOS transistor, 1000, with SiGe source and drains, 1004 and 1012, applying compressive stress to the channel region, 1002. Gate dielectric, 1006, and the gate polysilicon, 1008, overlie the channel region, 1002. As is illustrated by the arrows, the SiGe source and drains, 1004 and 1012, apply stress to the silicon causing the silicon crystal planes in the channel region, 1002, to be compressed.

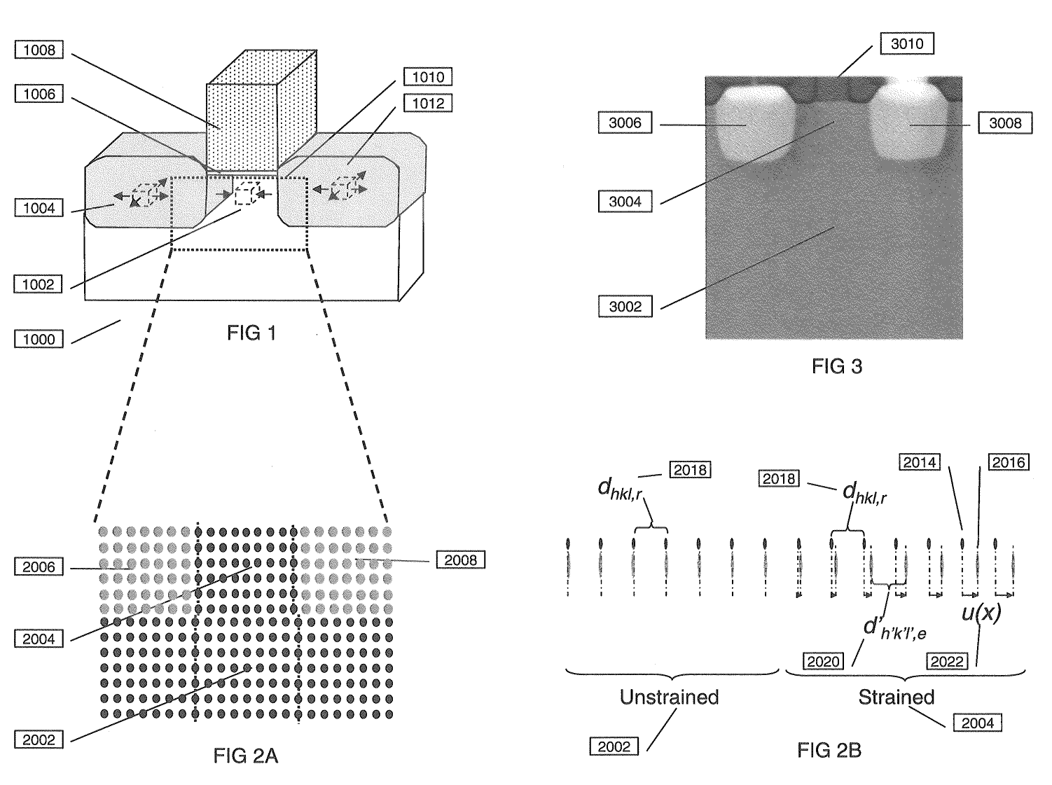

FIG. 2A is an expanded view of the callout box, 1010, in FIG. 1. Germanium atoms with a larger lattice constant have replaced some of the silicon atoms in the SiGe source 2006 and SiGe drain 2008 regions causing compressive stress to be applied to the channel region 2004. This compressive stress causes the silicon crystal planes in the channel to be displaced from their unstrained equilibrium positions as is illustrated in FIG. 2B. The dark spots 2014 represent the location of the unstrained silicon lattice in the substrate region 2002 and the lighter spots 2016 represent the location of the strained silicon lattice in the channel region 2004. d_{hkl,s}, 2018, is the distance between the crystal planes in the substrate, 2002. d′_{h′k′l′,c}, 2020, is the distance between the crystal planes in the channel, 2004. u(x), 2022, is the displacement of the strained silicon lattice in the channel region, 2004, caused by the compressive stress.

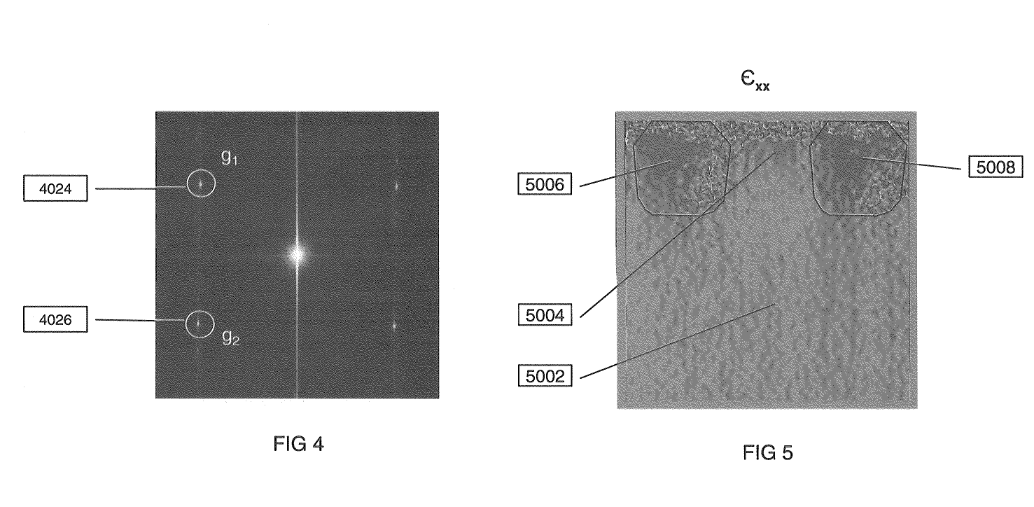

FIG. 4 is a diffractogram, which is the Fourier transform of the HAADF-STEM image in FIG. 3. If FIG. 3 included only perfect single crystal unstrained silicon substrate, the diffractogram in FIG. 4 would be sharply defined Bragg reflections. Because the electrons are scattered by unstrained silicon substrate 3002, strained silicon in the channel 3004 with a different lattice spacing, and SiGe source and drain regions 3006 and 3008 with yet another lattice spacing, the Bragg reflections in the diffractogram are diffuse and contain information regarding the different lattice spacing that may be analyzed using GPA to map the strain.

The HAADF-STEM image area may range from approximately 50 nm by 50 nm up to approximately 300 nm by 300 nm which is sufficiently large to include the entire source, drain, channel, and substrate region of a deep submicron device. The example sample image shown in FIG. 3 is of a deep submicron PMOS transistor and is approximately 250 nm by 250 nm. The image area may be the lowest possible magnification that still includes the (111) reflections in the fast Fourier transformed (FFT) diffractogram of the HAADF-STEM image. The sample may also range up to approximately 250 nm in thickness which is sufficient to avoid the stress relaxation caused by sample thinning encountered in HRTEM samples which must be thinned to approximately 50 nm.

Geometric phases extracted from the Bragg reflections in the Fourier phase image in FIG. 4, such as 4024 and 4026, may be related by GPA to the components of the displacement field, u(x,y) 2022

$$( \begin{matrix}{P}_{g 1} \\ {P}_{g 2}\end{matrix} ) = - 2 π ( \begin{matrix}{g}_{1 x} & {g}_{1 y} \\ {g}_{2 x} & {g}_{2 y}\end{matrix} ) ( \begin{matrix}{u}_{x} ( x , y ) \\ {u}_{y} ( x , y )\end{matrix} )$$

where P_{g1} is the phase image labeled g1, 4024, and P_{g2} is the phase image labeled g2, 4026, in FIG. 4. g₁ₓ and g_{1y} are the components of g1 in the x (horizontal, along the channel) and y (vertical, perpendicular to the channel through the gate) directions

$$g = \frac{1}{{d}_{hkl}}$$

where dₕₖₗ is the lattice vector perpendicular to the crystal plane described by the Miller indices, hkl. uₓ(x,y) and u_{y}(x,y) are displacement vector components of the displacement field at each point of the image in FIG. 3.

By selecting two different Bragg reflections such as 4024 and 4026 in FIG. 4, that contain information along two different directions in the crystal lattice the displacement field, u(x,y) may be calculated at each point in the HAADF-STEM image in FIG. 3.

The components of the two dimensional strain tensor are related to the displacement vector components, uₓ(x,y) and u_{y}(x,y).

$$∈ = ( \begin{matrix}{∈}_{xx} & {∈}_{xy} \\ {∈}_{yx} & {∈}_{yy}\end{matrix} ) = ( \begin{matrix}\frac{\partial {u}_{x} ( x , y )}{\partial x} & \frac{\partial {u}_{x} ( x , y )}{\partial y} \\ \frac{\partial {u}_{y} ( x , y )}{\partial x} & \frac{\partial {u}_{y} ( x , y )}{\partial y}\end{matrix} )$$

Since the displacement field is known at each point, the change in the displacement field along the x [along the channel in the (110) direction] and y [perpendicular to the channel in the (001) direction] may be determined and the components of the strain tensor calculated at each point.

A plot of the ∈_{C} component of the strain tensor is shown in FIG. 5. The substrate 5002 is relatively unstressed and the channel region 5004 shows compressive stress.

This technique of measuring strain is insensitive to small changes in microscope parameters and is also insensitive to small changes in sample thickness. Measured strain is significantly more insensitive to sample preparation than the currently used HRTEM method making strain measurements using this technique much more reproducible and more representative of the strain in the bulk sample.

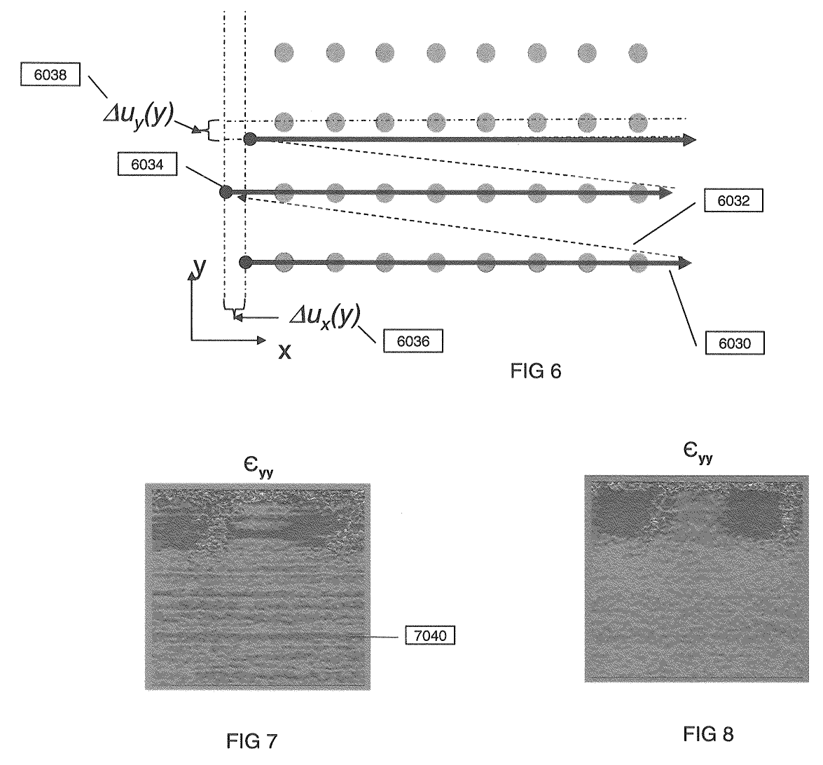

When a STEM image is being formed, the electron beam is commonly scanned in the horizontal, x-direction, parallel to the channel as shown in FIG. 6. After each scan, 6030, across the image, the beam returns (or flies back) to the starting point of the scan, 6034, and after indexing in the y-direction, proceeds to make another scan, 6034. If the electron beam does not return to exactly the same x location at the start of each scan, errors, Δuₓ(y), 6036, and Δu_{y}(y), 6038, may be introduced into the components of the displacement vector, that may change with each index in the y-direction. These errors are commonly referred to as fly-back error.

$$∈ = ( \begin{matrix}{∈}_{xx} & {∈}_{xy} \\ {∈}_{yx} & {∈}_{yy}\end{matrix} ) = ( \begin{matrix}\frac{\partial {u}_{x} ( x , y ) + Δ {u}_{x} ( y )}{\partial x} & \frac{\partial {u}_{x} ( x , y ) + Δ {u}_{x} ( y )}{\partial y} \\ \frac{\partial {u}_{y} ( x , y ) + Δ {u}_{y} ( y )}{\partial x} & \frac{\partial {u}_{y} ( x , y ) + Δ {u}_{y} ( y )}{\partial y}\end{matrix} )$$

Since the fly-back error terms that occur when the image is scanned in the x-direction are a function of y only, they do not contribute to the two terms that are related to the strain in the horizontal (channel) direction, ∈ₓₓ and ∈_{yx}, which are differentiated with respect to x, but they do contribute to the two terms related to the strain in the vertical direction, ∈_{xy} and ∈_{yy}. An image of the ∈_{yy} strain map that is formed using a horizontal, x-direction scan which includes the error term, Δu_{y}(y), is shown in FIG. 7. The horizontal striping, 7040, in the strain map is an artifact introduced by the fly-back error term.

Likewise if the image is formed by scanning in the y-direction, errors Δuₓ(x) and Δu_{y}(x), in the y components of the displacement vector may occur and may change with each index in the x-direction. Adding these errors to the displacement field tensor gives

$$∈ = ( \begin{matrix}{∈}_{xx} & {∈}_{xy} \\ {∈}_{yx} & {∈}_{yy}\end{matrix} ) = ( \begin{matrix}\frac{\partial {u}_{x} ( x , y ) + Δ {u}_{x} ( x )}{\partial x} & \frac{\partial {u}_{x} ( x , y ) + Δ {u}_{x} ( x )}{\partial y} \\ \frac{\partial {u}_{y} ( x , y ) + Δ {u}_{y} ( x )}{\partial x} & \frac{\partial {u}_{y} ( x , y ) + Δ {u}_{y} ( x )}{\partial y}\end{matrix} )$$

In this case when the image is formed by scanning the sample in the y-direction, the fly-back errors are a function of x only, so the errors do not contribute to the two right hand terms in the strain tensor, ∈_{xy} and ∈_{yy}, but do contribute to the two left hand terms, ∈ₓₓ and ∈_{yx}. The strain map image of ∈_{yy} with the scan in the y-direction is shown in FIG. 8. Since the fly-back error term is now eliminated, the horizontal artifact lines that were seen in the strain map image in FIG. 7 with the scan taken in the x-direction have been eliminated. If the strain maps of strain tensor components, ∈ₓₓ and ∈_{yx}, were made using the image formed by scanning the sample in the y-direction, vertical artifact lines caused by the horizontal fly-back error terms would result.

By using this technique of forming the strain maps of the strain tensor components related to the horizontal strain, ∈ₓₓ and ∈_{yx}, using HAADF-STEM images formed using horizontal, x-direction scans, and strain maps of strain tensor components related to vertical strain, ∈_{xy} and ∈_{yy}, using images formed using vertical, y-direction scans, strain maps free of fly-back error artifacts may be formed for all four components of the two dimensional strain tensor.

While various embodiments of the present invention have been described above, it should be understood that they have been presented by way of example only and not limitation. Numerous changes to the disclosed embodiments can be made in accordance with the disclosure herein without departing from the spirit or scope of the invention. Thus, the breadth and scope of the present invention should not be limited by any of the above described embodiments. Rather, the scope of the invention should be defined in accordance with the following claims and their equivalents.

What is claimed is:

1. A method of mapping the strain in a crystalline sample, comprising:
scanning in at least one direction to form a high angle annular dark field scanning transmission electron microscope (HAADF-STEM) image of said crystalline sample including at least two regions with different strain where a Fourier transform defractogram of said HAADF-STEM image includes (111) Bragg reflections;
selecting two independent Bragg reflections in said Fourier transform defractogram;
performing geometric phase analysis (GPA) with said two said independent Bragg reflections; and
forming a strain map of said sample for at least one term in a two dimensional strain tensor.

2. The method of claim 1 where said sample has an area between about 50 nm by 50 nm and about 300 nm by 300 nm and a thickness between about 50 nm and about 250 nm.

3. The method of claim 1 where said sample has an area of about 250 nm by 250 nm and a thickness of about 200 nm.

4. The method of claim 1 where said sample is a semiconductor device and where said HAADF-STEM image includes more than one portion of said semiconductor device.

5. The method of claim 4 where said sample is a MOS transistor and said HAADF-STEM image includes at least a portion of a source, drain, channel, and substrate of said MOS transistor.

6. The method of claim 4 where said sample is a bipolar transistor and said HAADF-STEM image includes at least a portion of an emitter, a base, a collector, and a substrate of said bipolar transistor.

7. The method of claim 1 where strain maps for horizontal strain related terms, ∈ₓₓ and ∈ₓ, in said two dimensional strain tensor are formed from HAADF-STEM images formed by scanning in a horizontal, x-direction and said strain maps for vertical strain related terms, ∈_{yy} and ∈_{xy}, terms in said two dimensional strain tensor are formed from HAADF-STEM images formed by scanning in a vertical, y-direction.

8. A method of mapping the strain in a crystalline sample, comprising:
forming a high angle annular dark field scanning transmission electron microscope (HAADF-STEM) image of said crystalline sample including at least two regions with different strain where a Fourier transform defractogram of said image includes (111) Bragg reflections by scanning in at least one scan direction;
selecting two independent Bragg reflections in said Fourier transform defractogram;
performing geometric phase analysis (GPA) with said two said independent Bragg reflections; and
forming a strain map of the sample for at least one term in a two dimensional strain tensor that is related to the strain in said scan direction.

9. The method of claim 8 where said scan direction is a horizontal, x-direction and where said term in said two dimensional strain tensor is at least one of horizontal related terms in said stress tensor, ∈ₓₓ and ∈_{yx}.

10. The method of claim 8 where said scan direction is a vertical, y-direction and where said term in said two dimensional strain tensor is at least one of vertical related terms in said stress tensor, ∈_{yy} and ∈_{xy}.

11. The method of claim 8 where said crystalline sample is a MOS transistor and where said two regions include a channel region and at least one of a source, drain, and substrate region.

12. The method of claim 8 where said crystalline sample is a bipolar transistor and where said two regions include a base region and at least one of a emitter, collector, and substrate region.

13. A method of mapping each of the components of the strain tensor in a semiconductor device, comprising:
forming a first high angle annular dark field scanning transmission electron microscope (HAADF-STEM) image of said semiconductor device including at least two regions with different strain where a first Fourier transform defractogram of said first image includes (111) Bragg reflections by scanning in a horizontal direction;
selecting first and second independent Bragg reflections from said Fourier transform defractogram;
performing a first geometric phase analysis (GPA) with said first and second independent Bragg reflections; and
forming a first and second strain map for two components of said strain tensor related to horizontal strain;
forming a second HAADF-STEM image of said semiconductor device including said two regions with different strain where a second Fourier transform defractogram of said second HAADF-STEM image includes (111) Bragg reflections by scanning in a vertical direction;
selecting third and fourth independent Bragg reflections from said second Fourier transform defractogram;
performing a second GPA with said third and fourth independent Bragg reflections; and
forming third and fourth strain maps for two components of said strain tensor related to vertical strain.

14. The method of claim 13 where said semiconductor device is a MOS transistor and where said two regions include a channel region and at least one of a source, drain, and substrate region.

15. The method of claim 13 where said semiconductor device is a bipolar transistor and where said two regions include a base region and at least one of a emitter, collector, and substrate region.
